(19) United States
(12) Patent Application Publication
(10) Pub. No.: US 2025/0162829 A1
(43) Pub. Date: May 22, 2025

(54) MOLDED ARTICLE, PRESSING DEVICE, SHEET CONVEYING DEVICE, AND IMAGE FORMING APPARATUS

(71) Applicant: Kenji TOMITA, Kanagawa (JP)

(72) Inventor: Kenji TOMITA, Kanagawa (JP)

(73) Assignee: Ricoh Company, Ltd., Tokyo (JP)

(21) Appl. No.: 18/883,157

(22) Filed: Sep. 12, 2024

(30) Foreign Application Priority Data
Nov. 22, 2023 (JP) 2023-198463

(51) Int. Cl. B65H 5/06; B65H 5/38; G03G 15/00

(52) U.S. Cl. CPC B65H 5/062; B65H 5/38; G03G 15/6529

(57) ABSTRACT

A molded article includes a boss having lightening portions, an opposing wall that intersects a surface on which the boss is formed and opposes a side surface of the boss, and a mold release portion of a hole shape or a groove shape disposed in the opposing wall to release a mold for forming a part of the boss. The lightening portions are disposed on a mold release portion side of the boss facing the mold release portion and on both sides with respect to a center of the boss in an orthogonal direction orthogonal to both an opening direction of the mold released from the mold release portion, and an extending direction of the boss. An edge in the orthogonal direction of each of the lightening portions on the mold release portion side is located at an outermost position of the boss in the orthogonal direction.

### CROSS-REFERENCE TO RELATED APPLICATION

This patent application is based on and claims priority pursuant to 35 U.S.C. § 119 (a) to Japanese Patent Application No. 2023-198463, filed on Nov. 22, 2023, in the Japan Patent Office, the entire disclosure of which is hereby incorporated by reference herein.

### BACKGROUND

### Technical Field

The present disclosure relates to a molded article, a pressing device, a sheet conveying device, and an image forming apparatus.

### Related Art

A molded article including a boss having a lightening portion is known.

For example, in a molded article, lightening portions are provided at four locations to form a boss having a cross-shaped section to prevent the occurrence of sink marks.

### SUMMARY

The present disclosure described herein provides a molded article that includes a boss, an opposing wall, and a mold release portion. The boss has lightening portions. The opposing wall intersects a surface on which the boss is formed and opposes a side surface of the boss. The mold release portion of a hole shape or a groove shape is disposed in the opposing wall to release a mold for forming a part of the boss. The lightening portions are disposed on a mold release portion side of the boss facing the mold release portion and on both sides with respect to a center of the boss in an orthogonal direction orthogonal to both an opening direction of the mold released from the mold release portion, and an extending direction of the boss. An edge in the orthogonal direction of each of the lightening portions on the mold release portion side is located at an outermost position of the boss in the orthogonal direction.

The present disclosure described herein further provides a pressing device that includes the molded article and a coil spring. The molded article is a spring holder having the boss. The coil spring is engaged with the boss to press a pressed member with a biasing force.

The present disclosure described herein further provides a sheet conveying device that includes a driven roller, a driving roller, and the pressing device. The driving roller rotates the driven roller to convey a sheet. The pressing device presses the driven roller, which is the pressed member, toward the driving roller.

The present disclosure described herein further provides an image forming apparatus that includes the sheet conveying device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an image forming apparatus according to an embodiment;

FIG. 2 is a perspective view illustrating a periphery of a registration roller pair;

FIG. 3 is a top view of a periphery of a registration roller pair as viewed from above;

FIG. 4 is a cross-sectional view taken along line A-A of FIG. 3;

FIG. 5 is a cross-sectional view taken along line E-E of FIG. 3;

FIG. 6 is a schematic view of a conveyance guide;

FIG. 7 is a schematic view illustrating another example of the conveyance guide;

FIG. 8 is a schematic configuration diagram illustrating an engagement boss according to a comparative example;

FIG. 9 is a schematic configuration diagram illustrating a mold structure for forming an engagement boss according to a comparative example;

FIG. 10 is a schematic configuration diagram illustrating another example of a mold structure for forming an engagement boss according to a comparative example;

FIG. 11 is a schematic configuration diagram illustrating another example of a mold structure for forming an engagement boss according to a comparative example;

FIG. 12 is a schematic view illustrating an example of a mold structure for forming an engagement boss without a lightening portion on a mold release portion side;

FIG. 13 is a schematic view of a mold structure forming an engagement boss according to an embodiment;

FIG. 14 is a schematic view of a mold structure for forming an engagement boss according to a modification;

FIG. 15 is a schematic view of a mold structure for forming an engagement boss according to another modification;

FIG. 16 is a schematic view of a mold structure for forming an engagement boss according to still another modification;

FIG. 17 is a view illustrating a state in which a pressing spring is engaged with the engagement boss illustrated in FIG. 16;

FIG. 18 is a schematic configuration diagram of an engagement boss obtained by improving the engagement boss illustrated in FIG. 16.

FIG. 19 is a view illustrating a state in which a pressing spring is engaged with the engagement boss illustrated in FIG. 18.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Below, embodiments of the present disclosure will be described based on the drawings. It is to be understood that those skilled in the art can easily modify and change the embodiments within the scope of the appended claims to form other embodiments, and these modifications and changes are included in the scope of the appended claims. The following description is an example of the embodiments of the present disclosure and does not limit the scope of the claims.

Now, an example of an electrophotographic printer (hereinafter, referred to as a printer) that forms an image by electrophotography is described as an electrophotographic image forming apparatus according to an embodiment of the present disclosure.

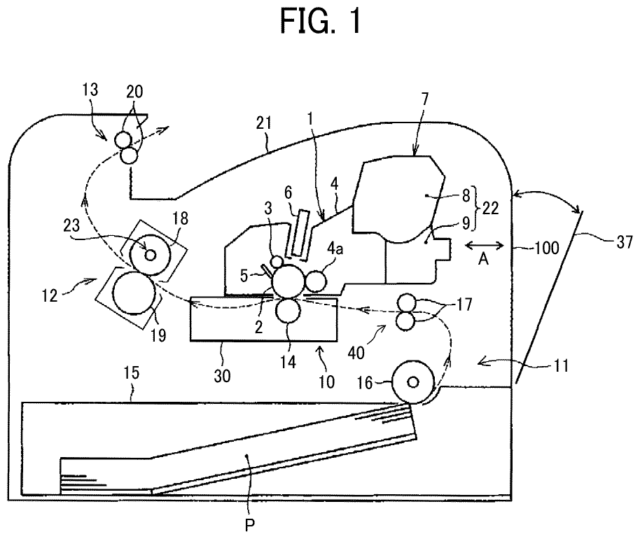

FIG. 1 is a schematic diagram illustrating a configuration of the image forming apparatus according to an embodiment.

A printer illustrated in FIG. 1 is a monochrome printer. A process cartridge 1 as a detachable unit is detachably attached to the apparatus main body 100. The process cartridge 1 includes a photoconductor 2 as an image bearer that bears an image on a surface thereof, and a charging roller 3 as a charging unit that charges a surface of the photoconductor 2. The process cartridge also includes a developing device 4 as a developing unit that visualizes a latent image on the photoconductor 2, a cleaning blade 5 as a cleaning unit that cleans a surface of the photoconductor 2, and the like. In addition, an LED head array 6 as an exposure unit that exposes the surface is disposed around the photoconductor 2.

A toner cartridge 7 as a developer container is detachably provided in the process cartridge 1. The toner cartridge 7 includes, in the container main body 22, a developer accommodating unit 8 that stores toner as developer to be supplied to the developing device 4. Furthermore, the toner cartridge 7 of the present embodiment also integrally includes a developer collector 9 that collects the toner (waste toner) removed by the cleaning blade 5.

The printer also includes a transfer unit 10 that transfers an image to a sheet material as a transfer material, a sheet feeding device 11 that supplies the sheet material, a sheet conveying device 40 that conveys the sheet material, a fixing device 12 that fixes the image transferred to the sheet material, and an output device 13 that ejects the sheet material to the outside of the device.

The transfer unit 10 includes a transfer roller 14 as a transfer member rotatably supported by a transfer frame 30. The transfer roller 14 is in contact with the photoconductor 2 in a state where the process cartridge 1 is attached to the apparatus main body 100, and a transfer nip is formed at an abutment between the process cartridge 1 and the photoconductor 2. The transfer roller 14 is connected to a power supply, and at least one of a predetermined direct current voltage (DC) or a predetermined alternating current voltage (AC) is applied to the transfer roller.

The sheet feeding device 11 includes a sheet feeding cassette 15 that accommodates a sheet material P and a sheet feeding roller 16 that feeds the sheet material P accommodated in the sheet feeding cassette 15. Further, a pair of registration roller pairs 17 as timing rollers that conveys the sheet material to a secondary transfer nip by measuring the conveyance timing is provided on the downstream side in the sheet material conveyance direction with respect to the sheet feeding roller 16. Examples of the sheet material P include cardboard, a postcard, an envelope, plain paper, thin paper, coated paper (coated paper, art paper, or the like), tracing paper, an OHP sheet, an OHP film, and the like.

The fixing device 12 includes a fixing roller 18 and a pressure roller 19. The fixing roller 18 is heated by an infrared heater 23 installed inside the fixing roller. The pressure roller 19 is pressed toward the fixing roller 18 and abuts on the fixing roller 18, and a fixing nip is formed at the abutment location.

The output device 13 includes an output roller pair 20. The sheet material ejected to the outside of the apparatus by the output roller pair 20 is stacked on a sheet ejection tray 21 formed by recessing the upper surface of the apparatus main body 100.

Next, a basic operation of a printer according to the present embodiment is described below with reference to FIG. 1. When the image forming operation is started, the photoconductor 2 of the process cartridge 1 is rotationally driven clockwise in FIG. 1, and the surface of the photoconductor 2 is uniformly charged to a predetermined polarity by the charging roller 3. Based on image information input from an external device, the charged surface of the photoconductor 2 is irradiated with light from the LED head array 6, and an electrostatic latent image is formed on the surface of the photoconductor 2.

By supplying toner to the electrostatic latent image formed on the photoconductor 2 by the developing device 4, the electrostatic latent image is visualized (visualized) as a toner image.

When the image forming operation is started, the transfer roller 14 is rotationally driven, and at least one of a predetermined direct current voltage (DC) and a predetermined alternating current voltage (AC) is applied to the transfer roller 14, whereby a transfer electric field is formed between the transfer roller 14 and the photoconductor 2.

In a lower portion of the apparatus main body 100, the sheet feeding roller 16 starts rotational driving, and the sheet material P is sent out from the sheet feeding cassette 15. Conveyance of the fed sheet material P is temporarily stopped by the registration roller pair 17 of the sheet conveying device 40.

Thereafter, the rotational drive of the registration roller pair 17 is started at a predetermined timing, and the sheet material P is conveyed to the transfer nip at the timing when the toner image on the photoconductor reaches the transfer nip. Then, the toner image on the photoconductor 2 is collectively transferred onto the sheet material P serving as a transfer body by the transfer electric field. Further, the residual toner on the photoconductor that has not been transferred to the sheet material P is removed by the cleaning blade 5, and the removed toner is conveyed to the developer collector 9 and collected.

Thereafter, the sheet material P to which the toner image has been transferred is conveyed to the fixing device 12, and the toner image on the sheet material P is fixed to the sheet material P in the fixing device 12. Then, the sheet material P is ejected to the outside of the apparatus by the output roller pair 20 and stocked on the sheet ejection tray 21.

An opening/closing cover 37 that is openable in a direction of an arrow in the drawing is provided on a side surface (right side surface in the drawing) of the apparatus main body 100. When the opening/closing cover 37 is opened, the process cartridge 1 is taken out from the apparatus main body through the opened opening.

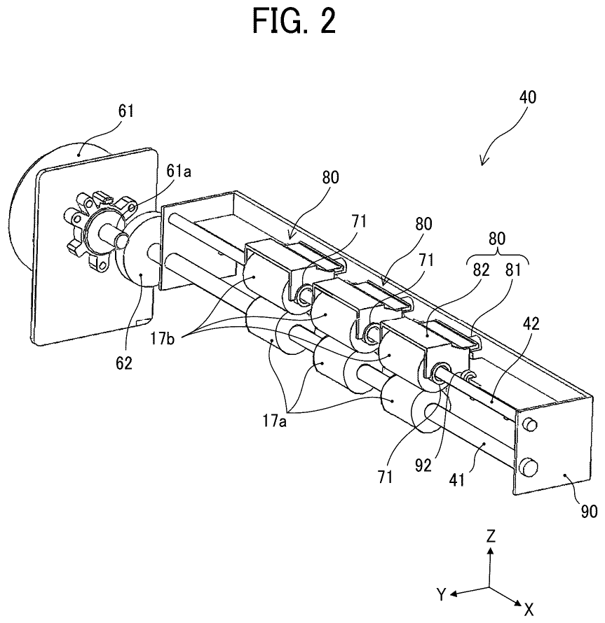

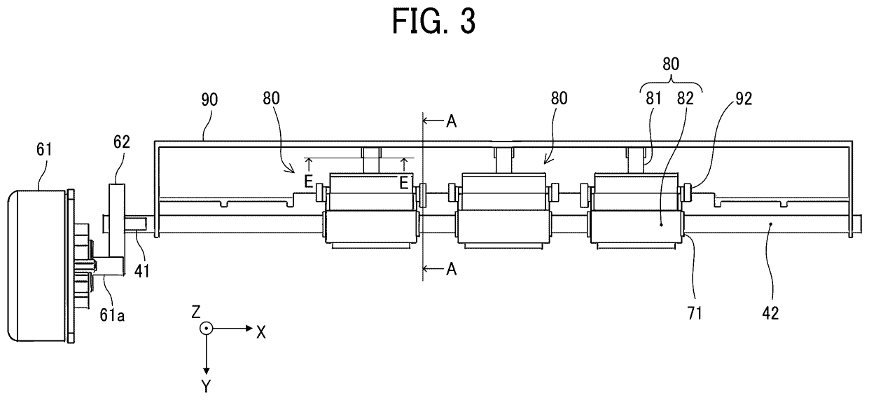

FIG. 2 is a perspective view illustrating a periphery of a registration roller pair 17 of the sheet conveying device 40, and FIG. 3 is a top view of the periphery of the registration roller pair 17 as viewed from above.

The registration roller pair 17 includes three driving rollers 17a provided at predetermined intervals in the axial direction, and three driven rollers 17b provided corresponding to the respective driving rollers 17a. The three driving rollers 17a are attached to a drive shaft 41 in such a manner that the three driving rollers 17a rotate integrally with the drive shaft 41.

On the other hand, the three driven rollers 17b are supported to be relatively rotatable with respect to a support shaft 42, and each of the driven rollers 17b is pressed toward the respective driving roller 17a by a pressing mechanism 80 serving as a pressing device. Each of three pressing mechanisms 80 provided corresponding to the respective driven rollers 17b serving as pressed members includes a pressing bracket 82 and a pressing spring 81 serving as a pressing member.

The drive shaft 41 is rotatably supported by a conveyance guide 90 via a bearing, the conveyance guide 90 being a molded article and serving as a spring holder, and the support shaft 42 is unrotatably fixed to the conveyance guide 90.

A drive gear 62 meshing with a motor gear 61a of the conveyance motor 61 serving as a drive source is attached to one end of the drive shaft 41 in such a manner that the drive gear 62 rotates integrally with the drive shaft 41. As a result, each driving roller 17a is rotationally driven by the driving force of the conveyance motor 61.

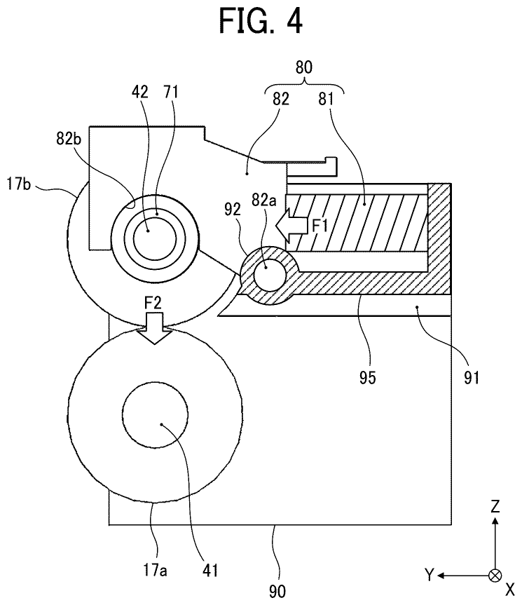

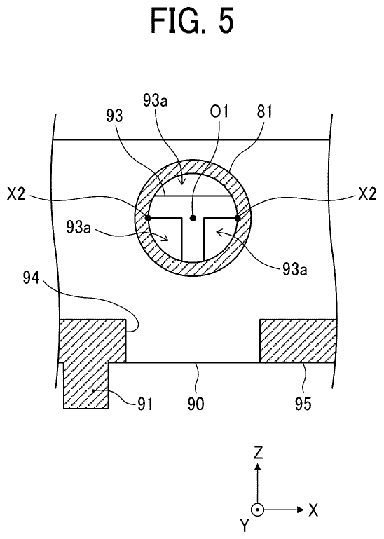

FIG. 4 is a cross-sectional view taken along line A-A of FIG. 3, and FIG. 5 is a cross-sectional view taken along line E-E of FIG. 3.

Support protrusions 82a are provided on both sides in the axial direction of the pressing bracket 82 of the pressing mechanism 80, and each support protrusion 82a is rotatably supported by a support hole 92 provided in the conveyance guide 90. The pressing bracket 82 has fitting portions 82b to be fitted into flange portions 71 provided at both ends of the driven roller 17b.

The pressing spring 81 is a coil spring, and as illustrated in FIG. 5, one end of the pressing spring 81 is engaged with an engagement boss 93 (see FIG. 5) provided in the conveyance guide 90. The pressing spring 81 is attached in a compressed state between the conveyance guide 90 and the pressing bracket 82, and biases a center portion of the pressing bracket 82 in a direction of an arrow F1 in FIG. 4. The pressing spring 81 urges the pressing bracket 82 to rotate counterclockwise in FIG. 4 with the support protrusion 82a as a fulcrum. As a result, the flange portions 71 of the driven roller 17b are pressed in the direction indicated by an arrow F2 in the drawing by the fitting portions 82b of the pressing bracket 82. As a result, the driven roller 17b abuts on the driving roller 17a at a predetermined abutment pressure, a conveyance nip is formed, and the driven roller 17b favorably rotates following the driving roller 17a.

Further, when the pressing spring 81 biases the center of the pressing bracket 82, the flange portions 71 provided on both sides in the axial direction of the driven roller can be evenly pressed, and the pressure distribution generated between the driving roller and the driven roller can be made even in the X direction. As a result, the occurrence of skew feeding and wrinkles of the sheet can be suppressed.

The conveyance guide 90 is a resin molded article (mold component), and in order to suppress sink marks, as illustrated in FIG. 5, lightening portions 93a are provided at three locations in the cylindrical engagement boss 93 and have a T-shaped cross section.

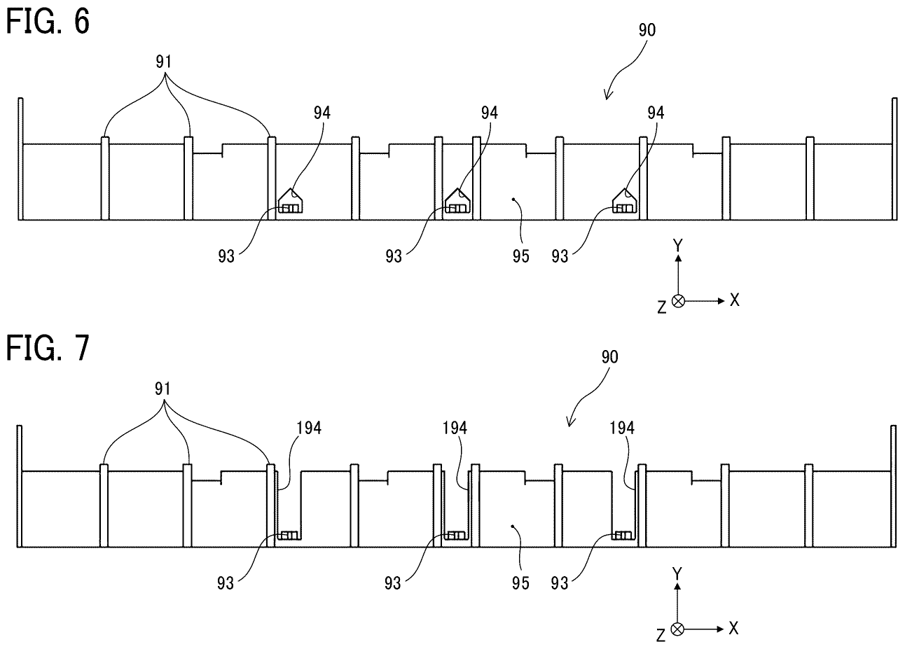

FIG. 6 is a schematic view of the conveyance guide 90.

As illustrated in FIG. 6, a plurality of guide ribs 91 extending in the sheet conveyance direction is provided at predetermined intervals in the axial direction (X direction) on the sheet opposing surface portion 95 of the conveyance guide 90, the sheet opposing surface portion 95 serving as an opposing wall opposing the sheet material. A hole-shaped mold release portion 94 formed to release the mold after the conveyance guide molding is provided at a location of the sheet opposing surface portion 95, the location opposing the engagement boss 93. As illustrated in FIG. 7, the mold release portion may be a groove-shaped mold release portion 194.

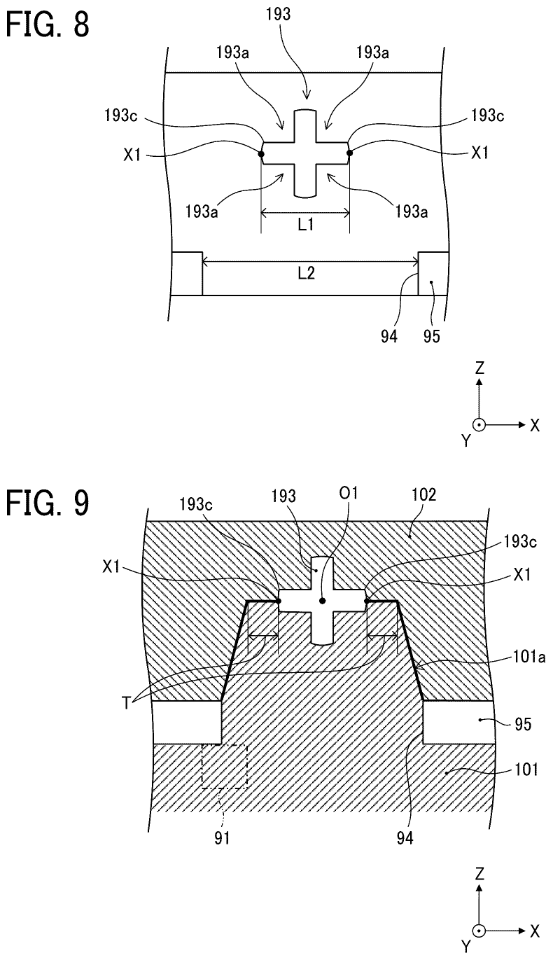

FIG. 8 is a schematic configuration diagram illustrating an engagement boss 193 according to a comparative example.

The engagement boss 193 illustrated in FIG. 8 has a cross shape in which lightening portions 193a are formed at four locations in the circumferential direction, and side surfaces 193c on both sides in the X direction of the engagement boss 193 are arcuate surfaces. The shape of the engagement boss 193 is that the center X1 of the side surface 193c in the Z direction is located at the outermost position in the X direction of the engagement boss 193. In the engagement boss 193 having such a shape, the mold release portion 94 becomes large in the X direction (the length L2 in the X direction of the mold release portion is longer than the length L1 in the X direction of the boss portion), and there is a possibility that the guide ribs 91 cannot be arranged at equal intervals in the X direction. Hereinafter, the reason why the mold release portion 94 is enlarged in the X direction will be described.

FIG. 9 is a schematic configuration diagram illustrating a mold structure for forming the engagement boss 193 according to a comparative example.

The engagement boss 193 of the conveyance guide is formed by aligning a first mold 101 and a second mold 102, which serve as release portions to be released from the mold release portion 94, in the vertical direction (Z direction) of the sheet opposing surface portion 95. The first mold 101 has a protrusion 101a protruding in the Z direction, and has an engagement boss forming portion at the tip of the protrusion 101a. Further, the protrusion 101a has a draft angle of about 3° so as to be easily released from the mold release portion 94 of the conveyance guide.

In addition, by providing the draft angle, when the second mold is displaced in the X direction with respect to the first mold, the second mold can be positioned at a prescribed position by the draft angle.

As illustrated in FIG. 9, the parting line between the first mold 101 and the second mold 102 is set at the center X1 in the Z direction of the side surfaces 193c on both sides in the X direction of the engagement boss 193. This is because, as illustrated in FIG. 10, when the side surfaces 193c on both sides in the X direction of the engagement boss 193 are formed by the second mold 102, the side of the center X1 of the side surface 193c closer to the first mold in the Z direction serves as the undercut portion Ud. As a result, the molded conveyance guide 90 cannot be released from the second mold 102.

In the engagement boss 193, as illustrated in FIG. 9, the tip of the protrusion 101a of the first mold 101 needs to have a shape extending in the X direction by T mm from the end in the X direction of the portion where the engagement boss 93 is formed. This is because, as illustrated in FIG. 11, in a case where the end in the X direction of the tip of the protrusion 101a of the first mold 101 is defined as the end in the X direction of the portion where the engagement boss 193 is formed, the thin portion U is formed at the tip of the protrusion 101a. This is because when such a thin portion U is present, the thin portion U is likely to be cracked or chipped, and the durability of the first mold 101 is reduced.

For these reasons, the engagement boss 193 illustrated in FIG. 8 needs to be formed in a mold shape as illustrated in FIG. 9, and the protrusion 101a of the first mold 101 becomes large in the X direction. As a result, after the conveyance guide 90 is molded, the mold release portion 94 configured in such a manner that the protrusion 101a can be released becomes large in the X direction.

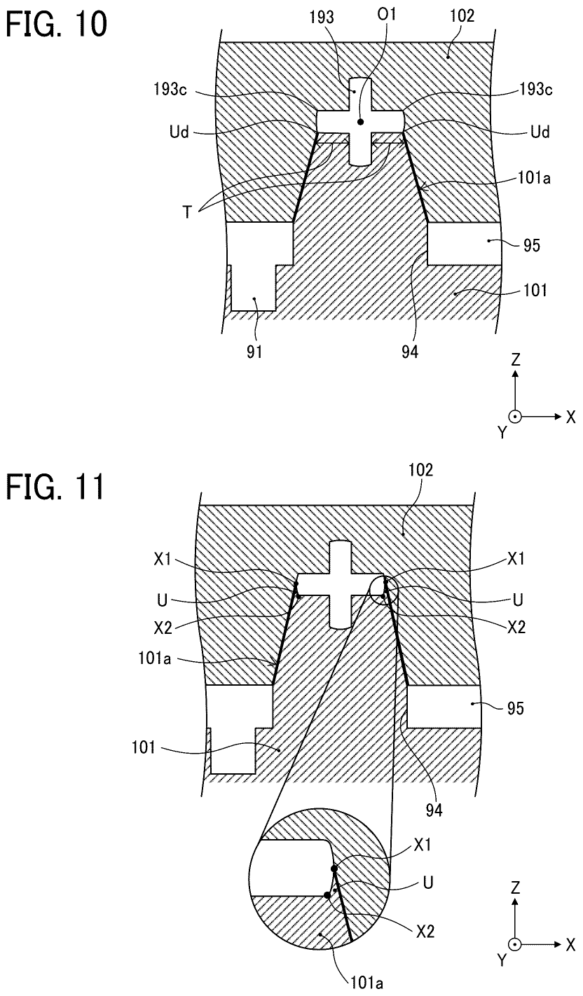

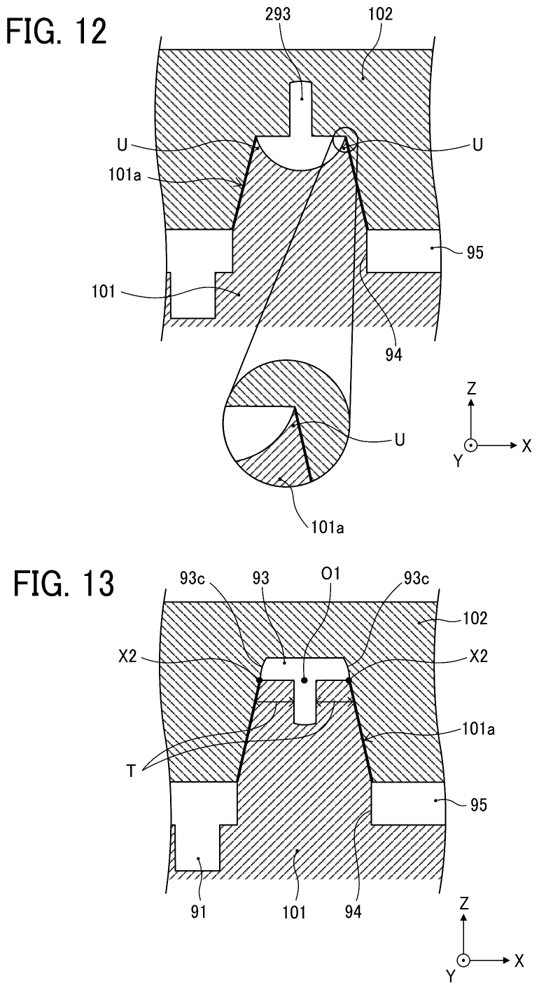

In addition, in a case where there are no lightening portions on both sides in the X direction on the mold release portion 94 side of the engagement boss, there is a possibility that the mold release portion 94 becomes large in the X direction and the guide ribs cannot be arranged at equal intervals in the X direction as described above. This is because, as illustrated in FIG. 12, in a case where the end in the X direction of the tip of the protrusion 101a of the first mold 101 is defined as the end in the X direction of the portion where the engagement boss 293 is formed, the thin portion U is formed at the tip of the protrusion 101a, and the durability of the first mold 101 is deteriorated. Therefore, in a case where there are no lightening portions on both sides in the X direction on the mold release portion 94 side of the engagement boss, the tip of the protrusion 101a of the first mold 101 has a shape extending in the X direction by T mm from the end in the X direction of the portion where the engagement boss is formed, and becomes large in the X direction of the protrusion 101a. As a result, the mold release portion 94 becomes large in the X direction, and the guide ribs cannot be arranged at equal intervals in the X direction.

On the other hand, as illustrated in FIG. 5, in the engagement boss 93 of the present embodiment, the lightening portions 93a are formed on both sides in the X direction of the engagement boss 93 on the mold release portion 94 side of the engagement boss 93, and an edge X2 in the X direction of each of the lightening portions 93a on the mold release portion 94 side is located at the outermost position in the X direction of the engagement boss 93.

Specifically, by lightening both sides in the X direction on the mold release portion 94 side up to a position of the center O1 of the engagement boss 93 in the Z direction, an edge X2 in the X direction of each of the lightening portions 93a on the mold release portion 94 side is located at the outermost position in the X direction of the engagement boss 93.

FIG. 13 is a schematic view of a mold structure forming the engagement boss 93 of the present embodiment.

In the engagement boss 93 of the present embodiment, the edge X2 in the X direction of each of the lightening portions 93a is located at the outermost position in the X direction of the engagement boss 93. As a result, even when the side surfaces 93c on both sides in the X direction of the engagement boss 93 are formed by the second mold 102, no undercut portion is generated.

In addition, lightening portions 93a are formed on both sides in the X direction on the mold release portion 94 side of the engagement boss 93 of the present embodiment. As a result, even when the tip of the protrusion 101a is not extended in the X direction from the end in the X direction of the portion where the engagement boss 93 is formed, the thickness on both sides in the X direction of the tip of the protrusion 101a of the first mold 101 can secure the thickness T necessary for the strength of the mold. As a result, the length in the X direction of the tip of the protrusion 101a of the first mold 101 can be substantially the length in the X direction of the engagement boss 93, and the protrusion 101a of the first mold 101 can be suppressed from increasing in size in the X direction. As a result, it is possible to suppress an increase in size in the X direction of the mold release portion 94 which is for releasing the protrusion 101a of the first mold 101. As a result, with the mold release portion 94, it is possible to suppress restriction on the arrangement of the guide ribs 91, and the guide ribs 91 can be arranged at equal intervals in the X direction.

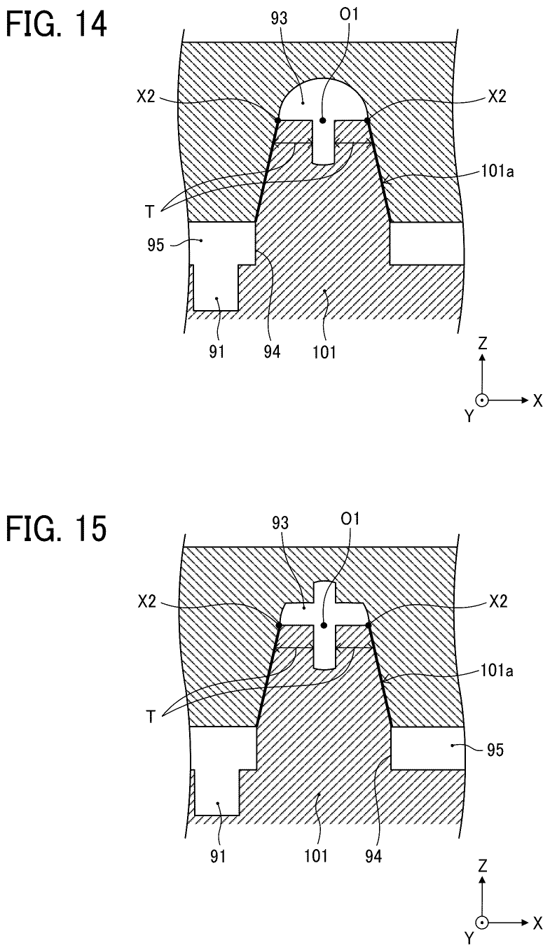

The engagement boss 93 may have the lightening portions 93a on both sides in the X direction on the mold release portion 94 side, and the edge X2 in the X direction of each of the lightening portions 93a on the mold release portion 94 side may be located at the outermost position of the engagement boss 93 in the X direction. Therefore, as illustrated in FIG. 14, the engagement boss 93 may have a shape in which the lightening portions 93a are provided only on both sides in the X direction on the mold release portion 94 side, or as illustrated in FIG. 15, may have a substantially cross shape by providing lightening portions at four locations in the circumferential direction of the engagement boss 93.

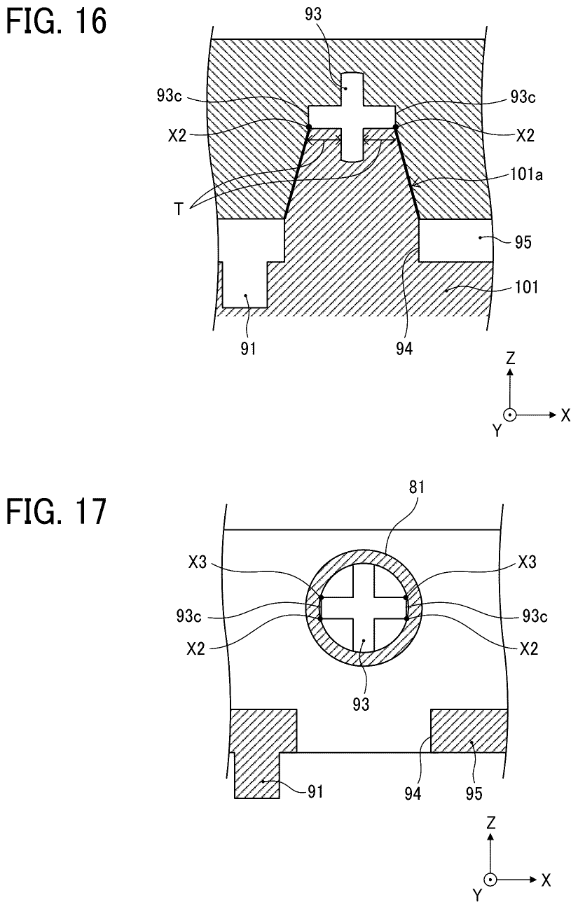

As illustrated in FIG. 16, side surfaces 93c on both sides in the X direction of the engagement boss 93 may be flat surfaces. In the shape of FIG. 16, the edge X2 in the X direction of each of the lightening portions 93a on the mold release portion 94 side is located at the outermost position in the X direction, and the side surfaces of the engagement boss on both sides in the X direction can be formed by the second mold. However, in the configuration illustrated in FIG. 16, as illustrated in FIG. 17, the positioning of the pressing spring 81 in the X direction is performed at both ends X2 and X3 in the Z direction of a flat portion of the engagement boss 93, and the positioning portion of the engagement boss in the X direction is in line contact with the pressing spring 81. Since the engagement boss 93 is made of resin and the pressing spring 81 is made of metal, in such a configuration, deformation or scraping is likely to occur at both ends in the Z direction of the flat portion of the engagement boss 93 at the time of assembling the pressing spring as compared with the case of surface contact with the pressing spring 81. When deformation or scraping occurs at both ends in the Z direction of the flat portion, positioning in the X direction cannot be performed, and the pressure distribution generated between the driving roller and the driven roller becomes uneven in the X direction, which may cause skew feeding or wrinkling of the sheet.

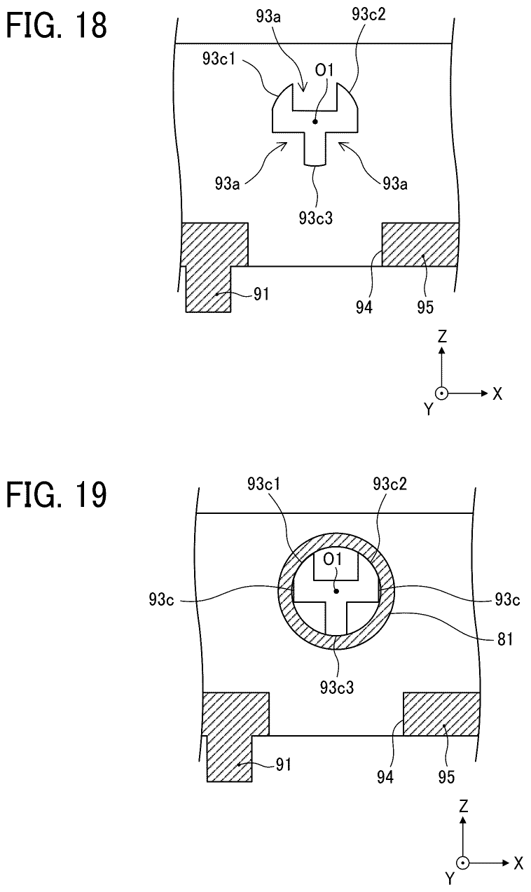

Therefore, for example, as illustrated in FIG. 18, it is preferable that positioning in the X direction and the Z direction can be performed on an arc-shaped side surface of the engagement boss 93. In the configuration illustrated in FIG. 18, as illustrated in FIG. 19, the pressing spring is positioned in the Z direction by two arc-shaped side surfaces 93cl and 93c2 on the opposite side to the mold release portion side and an arc-shaped side surface 93c3 on the mold release portion side. Further, the pressing spring 81 is positioned in the X direction by the side surfaces of the two arc-shaped side surfaces 93cl and 93c2 on the opposite side to the mold release portion side. In addition, since these arc-shaped side surfaces 93c1, 93c2, and 93c3 that position the pressing spring 81 are in surface contact with the pressing spring 81, scraping or deformation hardly occurs at the time of assembling the pressing spring. Therefore, with such a configuration, as illustrated in FIG. 18, the side surfaces 93c on both sides in the X direction of the engagement boss 93 are formed as flat surfaces, and even when deformation or scraping occurs at both ends in the Z direction of the flat surfaces, the pressing spring 81 can be positioned in the X direction.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

For example, in the present embodiment, the engagement boss engages with the pressing spring 81 to position the pressing spring 81, and the counterpart engaged with the engagement boss is not limited to a spring.

The configurations according to the above-descried embodiments are examples, and embodiments of the present disclosure are not limited to the above. For example, the following aspects can achieve effects described below.

### Aspect 1

According to Aspect 1, a molded article including a boss such as the engagement boss 93 having the lightening portions 93a includes: an opposing wall such as the sheet opposing surface portion 95 that intersects a surface on which the boss is formed and opposes a side surface of the boss; and a mold release portion of a hole shape or a groove shape such as the mold release portion 94 that is disposed in the opposing wall to release a mold for forming a part of the boss. The lightening portions are disposed on a mold release portion side of the boss facing the mold release portion and on both sides of the boss in an orthogonal direction (e.g., X direction) orthogonal to both an opening direction (e.g., Z direction) of a mold released from the mold release portion and an extending direction (e.g., Y direction) of the boss, and an edge (e.g., the edge X2) in the orthogonal direction of each of the lightening portions on the mold release portion side is located at an outermost position of the boss in the orthogonal direction (X direction).

As illustrated in FIGS. 11 and 12, a portion, which molds a boss of a mold (hereinafter, referred to as a release mold) to be released from the mold release portion 94 of the molded article such as the molded conveyance guide 90, is a tip portion of the protrusion 101a of the release mold 101. As illustrated in FIG. 12, in a case of a boss having no lightening portion on the mold release portion 94 side, thin portions U having a small thickness are formed on both sides in the above-described orthogonal direction (X direction: a direction orthogonal to both the extending direction (Y direction) of the boss and the opening direction (Z direction) of the release mold) of the tip of the protrusion 101a of the release mold 101. In addition, even when there are lightening portions on both sides in the orthogonal direction (X direction) on the mold release portion 94 side of the boss, in a case where the boss has the following shape, as illustrated in FIG. 11, thin portions U having a small thickness are formed on both sides in the orthogonal direction (X direction) of the tip portion of the protrusion 101a of the release mold 101. That is, as illustrated in FIG. 11, there is a portion (X1 in FIG. 11) located at the outermost position of the boss in the orthogonal direction (X direction) on the upstream side in the opening direction (Z direction) of the release mold with respect to an edge X2 in the orthogonal direction (X direction) of the lightening portion. In the case of such a shape, the portion (X1 in FIG. 11) located at the outermost position of the boss in the orthogonal direction (X direction) serves as a parting line of the mold, and thin portions U having a small thickness are formed on both sides in the orthogonal direction (X direction) of the tip portion of the protrusion 101a of the release mold 101.

As described above, when there are the thin portions U having a small thickness on both sides in the orthogonal direction (X direction) of the tip portion of the protrusion 101a of the release mold, there is a risk that cracking or chipping may occur on both sides. Therefore, conventionally, as illustrated in FIG. 9, the tip of the protrusion 101a of the release mold is made larger than the boss in the orthogonal direction (X direction) so that thin portions do not occur on both sides in the orthogonal direction (X direction) of the tip of the protrusion 101a of the release mold. As a result, the mold release portion 94 of the molded article becomes large.

On the other hand, in the present embodiment, the lightening portions 93a are formed on both sides in the orthogonal direction (X direction) of the mold release portion side of the boss, and the end portion X2 in the orthogonal direction (X direction) of the lightening portion 93a is positioned on the outermost side of the boss 93 in the orthogonal direction (X direction).

By positioning the end portion X2 in the orthogonal direction (X direction) of the lightening portion 93a on the outermost side of the boss 93 in the orthogonal direction (X direction), side surfaces on both sides in the X direction of the boss can be formed by the other mold (second mold 102) matched with the release mold. As a result, both ends in the orthogonal direction (X direction) of the boss forming portion at the tip of the protrusion 101a of the release mold become the end portions X2 in the orthogonal direction (X direction) of the lightening portion 93a.

Since the lightening portions 93a are formed on both sides in the orthogonal direction (X direction) on the mold release portion side of the boss, as illustrated in FIG. 13, even when the length in the orthogonal direction (X direction) of the tip of the protrusion 101a of the release mold is substantially the same as the outer diameter of the boss 93, the thickness on both sides in the orthogonal direction (X direction) of the tip of the protrusion 101a can be sufficiently secured. As a result, it is possible to suppress the protrusion 101a from becoming large in the orthogonal direction (X direction), and it is possible to suppress the mold release portion 94 from becoming large in the orthogonal direction (X direction).

### Aspect 2

According to Aspect 2, in Aspect 1, the boss such as the engagement boss 93 is inserted into a counterpart such as the pressing spring 81 cylindrical-shaped to position the counterpart, and the counterpart is positioned in the opening direction (Z direction) of the mold and the orthogonal direction (X direction) by an arc-shaped side surface of the engagement boss.

According to this, as described with reference to FIGS. 18 and 19, by forming the side surface of the engagement boss for positioning the counterpart into an arcuate surface, surface contact with the counterpart is achieved. As a result, it is possible to suppress deformation and scraping at the time of assembling the counterpart to the boss, as compared with the case of line contact with the counterpart. As a result, the counterpart can be favorably positioned in the opening direction (Z direction) of the mold and the orthogonal direction (X direction).

### Aspect 3

According to Aspect 3, in a pressing device such as the pressing mechanism 80, which includes a spring holder such as the conveyance guide 90 having a boss such as the engagement boss 93 with which a coil spring such as the pressing spring 81 is engaged and presses a pressed member such as the driven roller 17b with a biasing force of the coil spring, the spring holder is the molded article according to Aspect 1 or 2.

According to this, since the spring holder is accurately molded with suppressed sink marks and the like, the coil spring can be accurately held by the spring holder, and the pressed member can be evenly pressed.

### Aspect 4

According to Aspect 4, in Aspect 3, the coil spring such as the pressing spring 81 is disposed at a center portion of the pressing member such as the pressing bracket 82 that abuts on the pressed member such as the driven roller 17b to press the pressed member.

According to this, as described in the embodiment, the pressed member such as the driven roller 17b can be evenly pressed by the pressing member such as the pressing bracket 82.

### Aspect 5

According to Aspect 5, a sheet conveying device includes: a driving roller such as the driving roller 17a that rotates and drives; the driven roller such as the driven roller 17b that follows the driving roller to rotate; and the pressing mechanism such as the pressing mechanism 80 that presses the driven roller serving as the pressed member toward the driving roller. The sheet conveying device conveys a sheet by the driving roller such as the driving roller 17a and the driven roller such as the driven roller 17b, and the pressing device according to Aspect 3 or 4 is used as the pressing mechanism such as the pressing mechanism 80.

According to this, as described in the embodiment, the driven roller such as the driven roller 17b abuts on the driving roller such as the driving roller 17a at a predetermined abutment pressure, a conveyance nip is formed, and the driven roller can favorably rotate following the driving roller.

### Aspect 6

According to Aspect 6, in Aspect 5, the spring holder is the conveyance guide such as the conveyance guide 90 that guides the sheet, and a plurality of guide ribs such as the plurality of guide ribs 91 are provided on a surface of an opposing surface portion on an opposite side of an opposing surface of the opposing surface portion opposing the boss such as the engagement boss 93.

According to this, as described in the embodiment, since a mold release portion provided on the opposing surface portion can be downsized, it is possible to suppress the occurrence of a problem that the guide ribs such as the guide ribs 91 cannot be disposed at a desired position by the mold release portion.

### Aspect 7

According to Aspect 7, in an image forming apparatus including a sheet conveying device, the sheet conveying device according to Aspect 5 or 6 is used as the sheet conveying device.

According to this, as described in the embodiment, the sheet can be favorably conveyed.

1. A molded article, comprising:
a boss having lightening portions;
an opposing wall that intersects a surface on which the boss is formed and opposes a side surface of the boss; and
a mold release portion of a hole shape or a groove shape disposed in the opposing wall to release a mold for forming a part of the boss,
wherein the lightening portions are disposed on a mold release portion side of the boss facing the mold release portion and on both sides with respect to a center of the boss in an orthogonal direction orthogonal to both an opening direction of the mold released from the mold release portion, and an extending direction of the boss, and
an edge in the orthogonal direction of each of the lightening portions on the mold release portion side is located at an outermost position of the boss in the orthogonal direction.

2. The molded article according to claim 1,
wherein the boss is inserted into a cylindrical counterpart to position the cylindrical counterpart, and
the boss has an arc-shaped side surface to position the cylindrical counterpart in the opening direction of the mold and the orthogonal direction.

3. A pressing device, comprising:
the molded article according to claim 1 being a spring holder having the boss, and
a coil spring engaged with the boss to press a pressed member with a biasing force.

4. The pressing device according to claim 3, further comprising a pressing member to abut on and press the pressed member,
wherein the coil spring is disposed at a center portion of the pressing member.

5. A sheet conveying device, comprising:
a driven roller;
a driving roller to rotate the driven roller to convey a sheet; and
the pressing device according to claim 3 to press the driven roller, which is the pressed member, toward the driving roller.

6. The sheet conveying device according to claim 5,
wherein the spring holder is a conveyance guide to guide the sheet, and
a plurality of guide ribs are on a surface of the opposing wall on an opposite side of an opposing surface of the opposing wall opposing the boss.

7. An image forming apparatus, comprising the sheet conveying device according to claim 5.
